(19) United States
(12) Patent Application Publication
(10) Pub. No.: US 2009/0152063 A1
(43) Pub. Date: Jun. 18, 2009

(54) Pumping device for a hydraulic brake of a bicycle

(76) Inventor: Szu-fang Tsai, Changhua (TW)

Correspondence Address: SAM CHEN, 7F-1, 293, ROOSEVELT ROAD, SEC 3, TAIPEI, TW

(21) Appl. No.: 11/955,406

(22) Filed: Dec. 13, 2007

(51) Int. Cl. B60T 11/16

(52) U.S. Cl. 188/344

(57) ABSTRACT

A pumping device for a brake device of a bicycle includes a tunnel and a main cylinder directly and respectively disposed in a distal portion of a handlebar of the bicycle. The tunnel is provided to contain oil and the main cylinder is connected to the brake device. The tunnel and the main cylinder communicate with each other via a first hole and a second hole that are respectively defined in the distal portion of the handlebar of the bicycle. A pair of ears extends from a distal end of the handlebar and a lever pivotally connected to the pair of the ears for operating the main cylinder.

### BACKGROUND OF THE INVENTION

1. Field of the Invention

The present invention relates to a pumping device, and more particularly to a pumping device for a hydraulic brake of a bicycle.

2. Description of Related Art

A hydraulic brake system of a bicycle is divided into a brake device and a pumping device for providing pressed oil to the brake device. A conventional pumping device of a bicycle in accordance with the prior art shown in FIG. 6 comprises a hollow body (50) divided into a containing portion (51) for containing oil and a receiving portion (52) for receiving pumping elements, such as a piston and a spring. A lever (53) is pivotally mounted to the body (50) for operating the piston to pump oil to the brake device via an oil pipe.

However, the conventional pumping device for a hydraulic brake of the bicycle in accordance with the prior art has some disadvantages in manufacturing and use.

1. The body (50) of the conventional pumping device is previously molded, and processed the containing portion (51) and receiving portion (52) in detail. Finally, the piston, the spring and oil seals are respectively assembled. Consequently, the manufacturing steps of the conventional pumping device are complicated.

2. Most of the structures of the conventional pumping device are exposed such that these exposed structures may be hooked during transporting and be broken due to an accidental crash.

The present invention has arisen to mitigate and/or obviate the disadvantages of the conventional pumping device for a hydraulic brake of a bicycle.

### SUMMARY OF THE INVENTION

The main objective of the present invention is to provide an improved pumping device for a brake device of a bicycle, which is integrally formed with a handlebar of the bicycle.

To achieve the objective, the pumping device in accordance with the present invention comprises a tunnel and a main cylinder directly and respectively disposed in a distal portion of a handlebar of the bicycle. The tunnel is provided to contain oil and the main cylinder is connected to the brake device. The tunnel and the main cylinder communicate with each other via a first hole and a second hole that are respectively defined in the distal portion of the handlebar of the bicycle. A pair of ears extends from a distal end of the handlebar and a lever pivotally connected to the pair of the ears for operating the main cylinder.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a pumping device for a hydraulic brake of a bicycle in accordance with the present invention;

FIG. 2 is an exploded perspective view of the pumping device in FIG. 1;

FIG. 3 is an operational view of the pumping device of the present invention in cross section;

FIG. 4 is a first schematic view of the pumping device in accordance with the present invention;

FIG. 5 is a second schematic view of the pumping device in accordance with the present invention; and

FIG. 6 is a side plan view of a conventional pumping device for a hydraulic brake of a bicycle in accordance with the prior art.

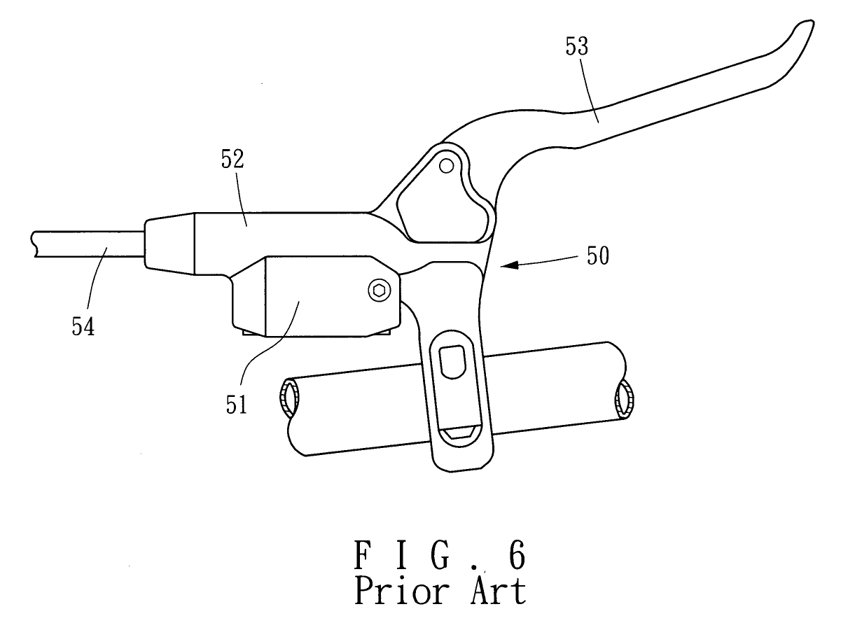

### DETAILED DESCRIPTION OF THE INVENTION

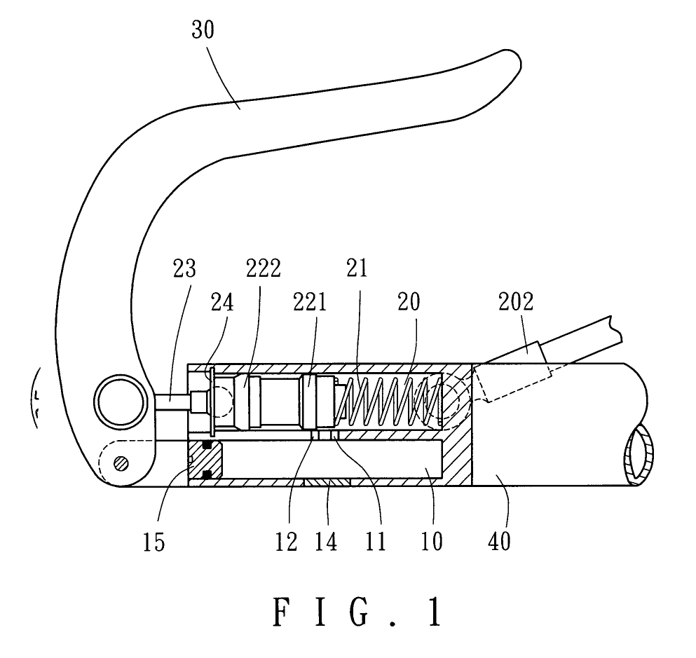

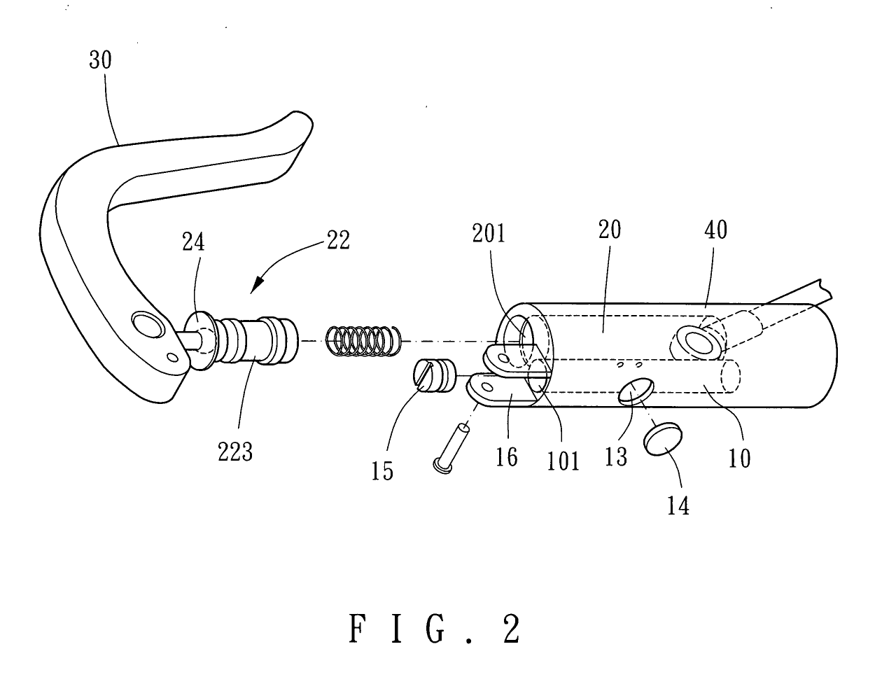

Referring to the drawings and initially to FIGS. 1 and 2, a pumping device for a hydraulic brake of a bicycle in accordance with the present invention comprises a tunnel (10) and a main cylinder (20) directly and respectively disposed in a distal portion of a handlebar (40) of the bicycle. The tunnel (10) and the main cylinder (20) communicate with each other via a first hole (11) and a second hole (12). For easily processing the tunnel (10) and the main cylinder (20) and assembling, the tunnel (10) and the main cylinder (20) respectively have an opening (101/201) defined in a distal end of the handlebar (40). In addition, a through hole (13) is defined to communicate with the tunnel (10) and correspond to the first hole (11) and the second hole (22) for easily processing the first hole (11) and the second hole (12) by a driller. A cover (14) is provided to airtightly closing the through hole (13) after processing the first hole (11) and the second hole (12). An airtight cover (15) is airtightly mounted into the opening (101) of the tunnel (10) for preventing the oil in the tunnel (10) from a leakage. A pair of ears (16) extending from the distal end of the handle bar (40) and a lever (30) is pivotally mounted to the pair of ears (16) for operating the main cylinder (20).

The main cylinder (20) includes a spring (21), a piston (22), a linkage (23) and a stopper (24) sequentially mounted therein. The stopper (24) is engaged to an inner periphery of the main cylinder (20) to prevent the spring (21), the piston (22) and the linkage (23) from detaching from the main cylinder (20). The spring (21) has two opposite ends respectively and longitudinally abutting against a bottom of the main cylinder (20) and the piston (22). A first oil seal (221) and a second oil seal (222) are respectively mounted to two opposite ends of the piston (22) and airtightly abutting the inner periphery of the main cylinder (20). An annular groove (223) is defined in an outer periphery of the piston (22) between the first oil seal (221) and the second oil seal (222). The first oil seal (221) is located between the first hole (11) and the second hole (12) when the lever (30) is in a free condition. In addition, the second oil seal (12) is never moved over the second hole (12). The first oil seal (221) is provided to compress the oil in the main cylinder (20) and the pumped oil is transmitted to the brake device via an oil pipe (202). The second oil seal (222) is provided to prevent the oil in the main cylinder (20) from a leakage via the second hole (12) during pumping oil because the second oil seal (12) is never moved over the second hole (12). The linkage (23) has a first end abutting against the piston (22) and a second end pivotally connected to the lever (30).

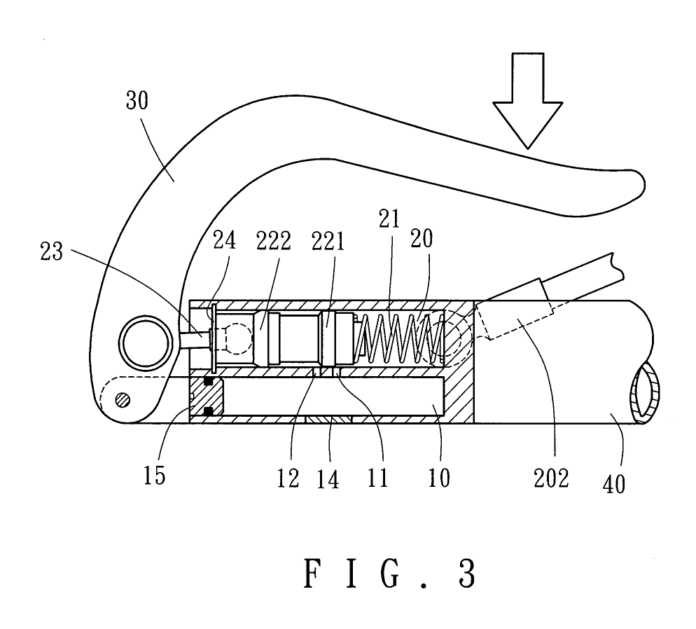

With reference to FIG. 3, the piston (22) is inward moved to compress the spring (21) due to the linkage (23) when the lever (30) is wrenched. The oil in the main cylinder (20) flows into the tunnel (10) via the first hole (11) when the first oil seal (221) is moved between the first hole (11) and the second hole (12). The oil in the tunnel (10) flows into the annular groove (223) via the second (12) hole when the pressure in the tunnel (10) is raised. The compressed oil in the main cylinder (20) is pumped to the brake device via the oil pipe (202) for braking the bicycle. When finishing the brake process, the lever (30) is in a free condition and the spring (21) backward push the piston (22). A minus pressure is occurred in the tunnel (10) and the oil in the annular groove (223) flow into the tunnel (10) due to the minus pressure in the tunnel (10) when the first oil seal (221) is backward moved over the first hole (11).

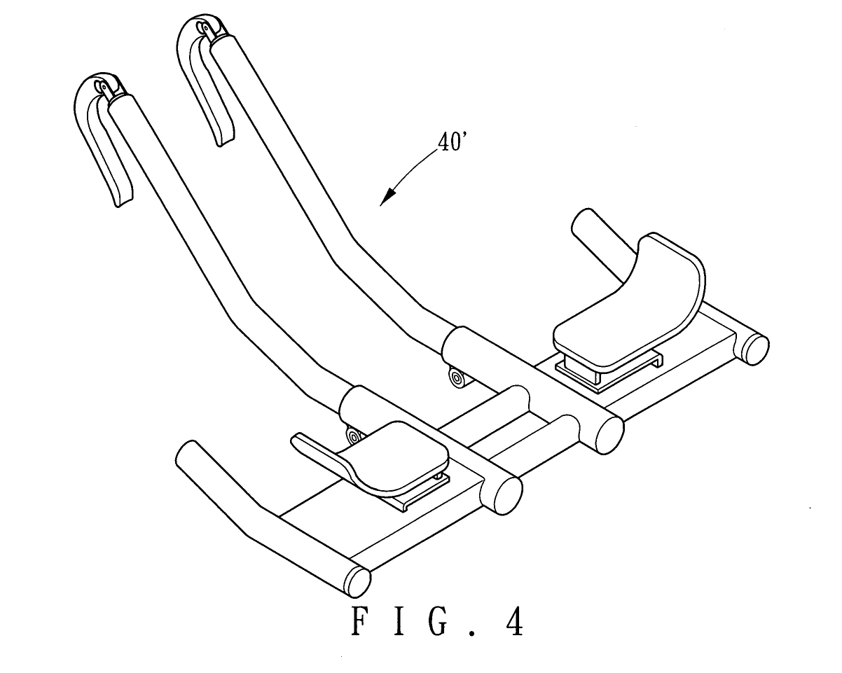

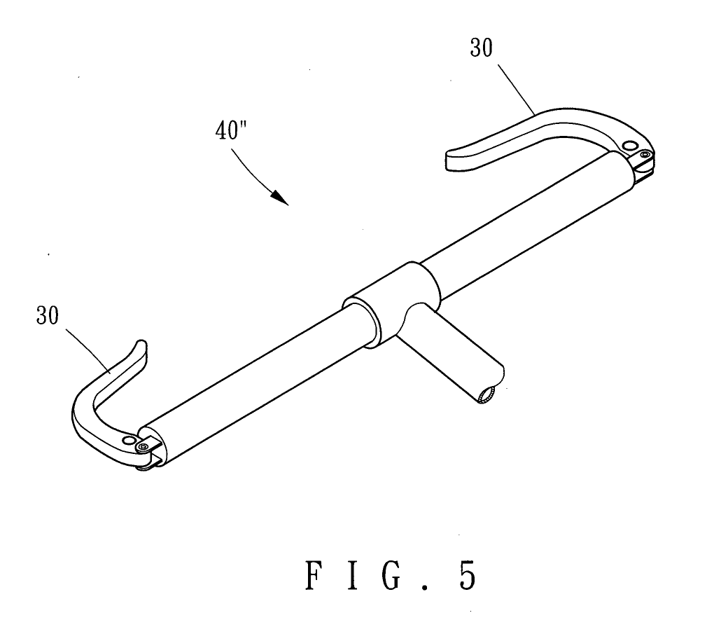

With reference to FIGS. 4 and 5, the pumping device in accordance with the present invention can be disposed to the handlebars of different type bicycles. As shown in FIG. 4, the pumping device of the present invention is used in a handlebar (40′) of a racing bicycle. As shown in FIG. 5, the pumping device of the present invention is used in a handlebar (40″) of a mountain bicycle

As described above, the pumping device for a hydraulic brake of a bicycle in accordance with the present invention has several advantages as follows.

1. The structure is simplified and easily assembled. The pumping device of the present invention is directly disposed in a distal portion of a handlebar (40) of a bicycle such that the locking element is unnecessary to the present invention.

2. The mold for molding the body of a conventional pumping device for a brake device of a bicycle is unnecessary to the present invention such that the manufacturing cost is reduced.

Although the invention has been explained in relation to its preferred embodiment, it is to be understood that many other possible modifications and variations can be made without departing from the spirit and scope of the invention as hereinafter claimed.

What is claimed is:

1. A pumping device for a brake device of a bicycle comprising a tunnel and a main cylinder adapted to be directly and respectively disposed in a distal portion of a handlebar of the bicycle, the tunnel provided to contain oil and the main cylinder adapted to be connected to the brake device, the tunnel and the main cylinder communicating with each other via a first hole and a second hole that are respectively defined in the distal portion of the handlebar of the bicycle, a pair of ears extending from a distal end of the handlebar and a lever pivotally connected to the pair of the ears for operating the main cylinder.

2. The pumping device as claimed in claim 1, wherein the main cylinder includes a piston, a linkage and a stopper sequentially mounted therein, the piston reciprocally moved in the main cylinder for pumping oil, the linkage having a first end abutting against the piston and a second pivotally connected to the lever, the stopper engaged to an inner periphery of the main cylinder to prevent the piston and the linkage from detaching from the main cylinder, a first oil seal and a second oil seal respectively mounted to two opposite ends of the piston and airtightly abutting the inner periphery of the main cylinder, an annular groove defined in an outer periphery of the piston between the first oil seal and the second oil seal, the first oil seal located between the first hole and the second hole when the lever is in a free condition, and the second oil seal never moved over the second hole.

3. The pumping device as claimed in claim 1, wherein each of the tunnel and the main cylinder has an opening defined in the distal end of the handlebar, an airtight cover mounted into the opening of the tunnel for airtightly closing the tunnel.

4. The pumping device as claimed in claim 1, wherein a through hole is defined to communicate with the tunnel and corresponds to the first hole and the second hole for easily processing the first hole and the second hole, a cover provided to airtightly closing the through hole after processing the first hole and the second hole.

5. The pumping device as claimed in claim 2, wherein each of the tunnel and the main cylinder has an opening defined in the distal end of the handlebar, an airtight cover mounted into the opening of the tunnel for airtightly closing the tunnel.

6. The pumping device as claimed in claim 2, wherein a through hole is defined to communicate with the tunnel and corresponds to the first hole and the second hole for easily processing the first hole and the second hole, a cover provided to airtightly closing the through hole after processing the first hole and the second hole.

7. The pumping device as claimed in claim 2 further comprising a spring mounted in the main cylinder, the spring having two opposite ends respectively abutting against a bottom of the main cylinder and the piston for providing a restitution force to the piston after pumping oil.

8. The pumping device as claimed in claim 3, wherein a through hole is defined to communicate with the tunnel and corresponds to the first hole and the second hole for easily processing the first hole and the second hole, a cover provided to airtightly closing the through hole after processing the first hole and the second hole.

9. The pumping device as claimed in claim 5 further comprising a spring mounted in the main cylinder, the spring having two opposite ends respectively abutting against a bottom of the main cylinder and the piston for providing a restitution force to the piston after pumping oil.

10. The pumping device as claimed in claim 6 further comprising a spring mounted in the main cylinder, the spring having two opposite ends respectively abutting against a bottom of the main cylinder and the piston for providing a restitution force to the piston after pumping oil.
